(19) United States
(12) Patent Application Publication
(10) Pub. No.: US 2011/0200900 A1
(43) Pub. Date: Aug. 18, 2011

(54) FEED FORWARD FUEL CONTROL ALGORITHM TO DECREASE FUEL CELL VEHICLE START UP TIME

(75) Inventors: Daniel I. Harris, Honeoye Falls, NY (US); Patrick Frost, Tucson, AZ (US); Gary M. Robb, Honeoye Falls, NY (US)

(73) Assignee: GM GLOBAL TECHNOLOGY OPERATIONS, INC., Detroit, MI (US)

(21) Appl. No.: 12/707,387

(22) Filed: Feb. 17, 2010

(51) Int. Cl. H01M 8/04

(52) U.S. Cl. 429/429

(57) ABSTRACT

A method for monitoring the pressure in an anode sub-system of a fuel cell system during a pressurization stage at system start-up prior to an anode purge. The method includes providing hydrogen gas to the anode sub-system during the pressurization stage, typically from one or more injectors. The method determines how many moles of the hydrogen gas has been provided to the anode sub-system, and uses the number of moles to determine the pressure in the anode sub-system. The method uses the determined pressure to stop the pressurization stage when the determined pressure is about equal to the desired pressure.

### BACKGROUND OF THE INVENTION

1. Field of the Invention

This invention relates generally to a method for monitoring the pressure within an anode sub-system of a fuel cell stack during a pressurization stage at start-up of the system and, more particularly, to a method for monitoring the pressure within an anode sub-system of a fuel cell system during a pressurization stage at start-up of the system that includes determining the number of moles of hydrogen gas that have been delivered to the anode sub-system during the pressurization stage, knowing the pressure in the anode sub-system at initiation of the pressurization stage, using the universal gas constant, knowing the temperature of the hydrogen gas and knowing the volume of the anode sub-system.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

In order to provide even hydrogen distribution of hydrogen gas to the anode flow channels in the bipolar plates during fuel cell system start-up, it is typically necessary to rapidly purge gas out of an anode header through a purge valve. When the hydrogen gas is filling the anode header, it is important that the anode pressure remains nearly constant to prevent hydrogen gas from entering the stack. In order to insure an accurate and consistent pressure control during the anode header purge stage, it is necessary to elevate the pressure in the anode sub-system before the hydrogen gas reaches the stack. This pressure elevation is generally done during a pressurization stage just prior to the anode header purge stage. Because the header purge valve outlet is pressure-referenced to the stack cathode exhaust pressure during the anode header purge, it is necessary to increase the anode pressure significantly above the cathode exhaust pressure in order to provide a rapid start-up. The size of the header purge valve dictates the desired pressure at the end of the pressurization stage. The time required to meet the pressure required for the beginning of the anode header purge stage should be minimized to decrease the start-up time.

The anode header purge stage may start as soon as the anode has reached the desired pressure above a cathode exhaust pressure. To reduce the system start-up time, a very high hydrogen gas flow rate is desired during the anode pressurization stage. The limitations of known anode pressure sensors are factors in determining when to start purging the anode header. For example, a typical pressure sensor has a response time of about 250 ms, which is longer than the time allotted for the pressurization stage and other fuel cell system requirements that is part of a two second start-up sequence.

It has been shown that the end of the pressurization stage is directly identified by a pressure sensor measurement. Due to the low pressure sensor response and the cycle time of the system controller, the actual final pressure is typically greater than desired. This pressure overshoot is a function of the injector flow rate. Pressure overshoot during the anode pressurization stage is not acceptable because hydrogen gas may enter the wet end of the anode active area in the stack.

In order to achieve an accurate end of the pressurization stage, the flow rate of the hydrogen gas has to be reduced. However, limiting the injector flow rate increases the start-up time. Thus, it is necessary to bring the anode sub-system pressure up to a desired value very quickly without overshooting the desired pressure. However, as discussed above, the pressure sensors that are typically employed cannot respond fast enough to the increasing anode pressure, and typically overshoot the desired pressure. One solution to this problem has been to limit the anode pressure during start-up, which increases the start-up time, in order to allow the pressure sensors to more accurately follow the increasing pressure in the anode sub-system. However, what would be more desirable is to have a rapid flow of hydrogen gas to the stack at start-up without the pressure overshoot.

### SUMMARY OF THE INVENTION

In accordance with the teachings of the present invention, a method is disclosed for monitoring the pressure in an anode sub-system of a fuel cell system during a pressurization stage at system start-up prior to an anode purge. The method includes providing hydrogen gas to the anode sub-system during the pressurization stage, typically from one or more injectors. The method determines how many moles of the hydrogen gas has been provided to the anode sub-system, and uses the number of moles to determine the pressure in the anode sub-system. The method uses the determined pressure to stop the pressurization stage when the determined pressure is about equal to the desired pressure.

In one embodiment, the desired pressure, the initial anode sub-system pressure at initiation of the pressurization stage, the volume of the anode sub-system, the temperature of the hydrogen gas and the universal gas constant are used to determine how many moles have been delivered to the anode sub-system. In an alternate embodiment, the number of moles delivered to the anode sub-system, the volume of the anode sub-system, the initial pressure of the anode sub-system at initiation of the pressurization stage, the temperature of the hydrogen gas and the universal gas constant are used to generate an observe anode pressure that is compared to the desired pressure.

Additional features of the present invention will become apparent from the following description and appended claims, taken in conjunction with the accompanying drawings.

### BRIEF DESCRIPTION OF THE DRAWING

FIG. 1 is a schematic plan view of a fuel cell system.

### DETAILED DESCRIPTION OF THE EMBODIMENTS

The following discussion of the embodiments of the invention directed to a method for monitoring the pressure within an anode sub-system of a fuel cell system during system start-up is merely exemplary in nature, and is in no way intended to limit the invention or its applications or uses.

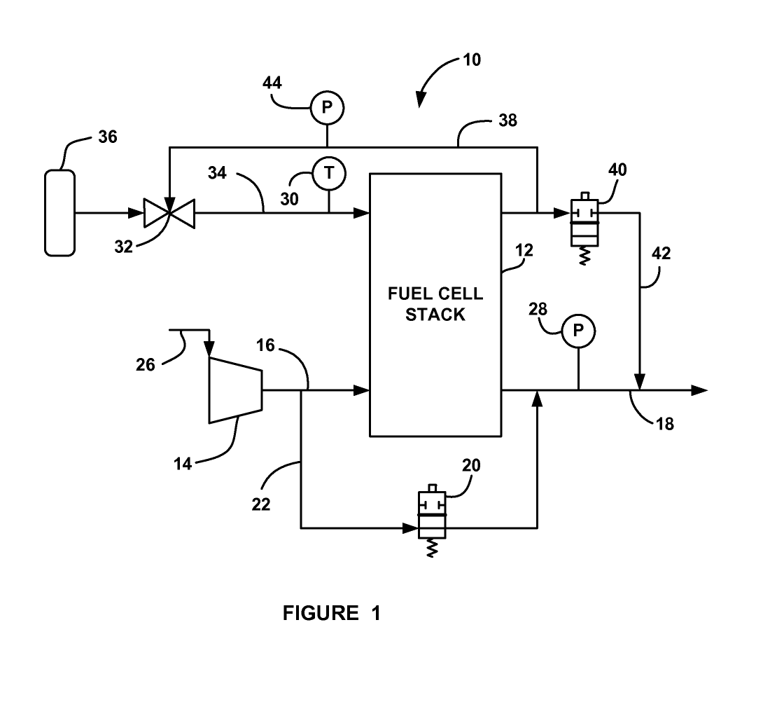

FIG. 1 is a schematic plan view of a fuel cell system 10 including a fuel cell stack 12. A compressor 14 provides compressed air to the cathode side of the fuel cell stack 12 on a cathode input line 16. A cathode exhaust gas is output from the fuel cell stack 12 on a cathode exhaust gas line 18. A pressure sensor 28 measures ambient pressure in the exhaust line. A by-pass valve 20 is provided in a by-pass line 22 that directly connects the cathode input line 16 to the cathode output line 18 to by-pass the stack 12. Thus, selectively controlling the by-pass valve 22 determines how much of the cathode air will flow through the stack 12 and how much of the cathode air will by-pass the stack 12.

An injector 32 injects hydrogen gas into the anode side of the fuel cell stack 12 on anode input line 34 from a hydrogen source 36, such as a high pressure tank. The anode gas that is exhausted from the fuel cell stack 12 is recirculated back to the injector 32 on a recirculation line 38, where the injector 32 also acts as a pump to draw the anode exhaust gas. As is well understood in the art, it is periodically necessary to bleed the anode exhaust gas to remove nitrogen from the anode side of the stack 12. A bleed valve 40 is provided in an anode exhaust line 42 for this purpose, where the bled anode exhaust gas is combined with the cathode exhaust gas on the line 18 to dilute any hydrogen within the anode exhaust gas to be below combustible limits. A temperature sensor 30 measures the temperature of the hydrogen gas in the line 34 being provided to the fuel cell stack 12.

By having certain knowledge of a fuel cell system and a simple model, it is possible to reduce the start-up time of the fuel cell system during a pressurization stage by providing a more appropriate control of the injector flow rate of the injector. As discussed above, the pressurization stage is required prior to the anode purge stage that is necessary to provide an even distribution of hydrogen gas to the anode flow channels. The present invention proposes two embodiments for achieving this goal.

A first embodiment is referred to as an integral method and employs knowledge of the volume of the anode sub-system and a constant injector flow. Based on these two assumptions, it is possible to predict the time required to provide enough moles of gas to the anode sub-system to raise the anode sub-system pressure to the desired pressure. The pressure at the start of the pressurization stage can be assumed to be steady-state because the system is off before the stage. The integral method proposes providing equation (1) below to calculate what it necessary for the system to remain in and end from the pressurization stage.

$${\int }_{0}^{t} \dot{n} d t \leq \frac{( {P}_{final} - {P}_{int} ) \cdot V}{RT} \qquad ( 1 )$$

Where P_{final} is the desired anode pressure at the end of the pressurization stage (kPa), Pᵢₙₜ is the anode pressure at the start of the pressurization stage (kPa), R is the universal gas constant (8.314 J/mol*K), T is the anode gas temperature (K), \dot{n} is the molar flow rate into the anode sub-system (mol/s) and V is total anode sub-system volume (L).

The integral part of equation (1) includes the molar flow rate it into the anode of the stack 12, and includes a model based on a particular injector or valve having a particular duty cycle and orifice size. The molar flow rate \dot{n} is compared to the predicted or required moles

$$( {P}_{final} - {P}_{int} ) \times \frac{V}{RT}$$

to meet the desired pressure on the right side of the inequality in equation (1) based on the ideal gas law. Therefore, as the integral value increases in equation (1) as the injector 32 injects more hydrogen gas into the anode header during the pressurization stage of the start-up sequence, eventually it will be greater than the number of moles of the gas on the right side of equation (1). This indicates to the system controller that the anode sub-system includes enough gas to provide the desired pressure P_{final}, where the control algorithm can then go to the anode header purge stage.

A second embodiment is referred to as an observer method and can be provided to simplify the controls implementation where the existing anode pressure controller for the run state can be used, although it requires the construction of a pressure observer. By reversing equation (1) and feeding back an observed pressure, the speed of the start-up sequence can be increased with minimal changes to the control architecture. This reversal of equation (1) is given as:

$${P}_{obs} = \frac{[ {\int }_{o}^{t} \dot{n} d t ] \cdot RT}{V} + {P}_{int} \qquad ( 2 )$$

Where P_{obs} is the observed anode pressure used as feedback (kPa), Pᵢₙₜ is the anode pressure at the start of the pressurizations stage (kPa), R is the universal gas constant (8.314 J/mol*K), T is the anode gas temperature (K), \dot{n} is molar flow rate into the anode sub-system (mol/s) and V is the total anode sub-system volume (L).

In this embodiment, as the injector 32 injects hydrogen gas into the anode sub-system and is integrated over time, the observed anode pressure P_{obs} that is used as a feedback will increase, and when the observed anode pressure P_{obs} equals a predetermined pressure set point Pₛₚ, the anode sub-system has the proper pressure and the header purge stage can be started.

Therefore, using the embodiments discussed above, the pressure in the anode sub-system can be accurately determined without the need to use a measured value from an anode pressure sensor. Thus, the pressure of the anode sub-system will not be overshot during the pressurization stage.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for pressurizing an anode sub-system of a fuel cell system to a desired pressure during a pressurization stage at system start-up, said method comprising:
providing hydrogen gas to the anode sub-system during the pressurization stage;
determining how many moles of the hydrogen gas have been provided to the anode sub-system during the pressurization stage; and
using the number of moles of the hydrogen gas to determine the pressure in the anode sub-system.

2. The method according to claim 1 wherein using the number of moles of the hydrogen gas to determine the pressure in the anode sub-system includes using the volume of the anode sub-system and a constant hydrogen gas flow rate.

3. The method according to claim 1 wherein determining how many moles of the hydrogen gas have been provided to the anode sub-system includes integrating a molar flow rate of the hydrogen gas.

4. The method according to claim 3 wherein using the number of moles of the hydrogen gas to determine the pressure within the anode sub-system includes using the equation:
$${\int }_{0}^{t} \dot{n} d t \leq \frac{( {P}_{final} - {P}_{int} ) \cdot V}{RT}$$
where P_{final} is the desired anode sub-system pressure at the end of the pressurization stage (kPa), Pᵢₙₜ is an anode sub-system pressure at the start of the pressurization stage (kPa), R is the universal gas constant (8.314 J/mol*K), T is a hydrogen gas temperature (K), \dot{n} is a molar flow rate into anode sub-system (mol/s) and V is a total anode sub-system volume (L).

5. The method according to claim 1 wherein determining how many moles of the hydrogen gas have been provided to the anode sub-system includes using a valve model.

6. The method according to claim 1 wherein using the number of moles of the hydrogen gas to determining the pressure within the anode sub-system includes using the equation:
$${P}_{obs} = \frac{[ {\int }_{o}^{t} \dot{n} d t ] \cdot RT}{V} + {P}_{int}$$
where P_{obs} is an observed anode sub-system pressure, (kPa), Pᵢₙₜ is an anode sub-system pressure at the start of the pressurizations stage (kPa), R is the universal gas constant (8.314 J/mol*K), T is a hydrogen gas temperature (K), \dot{n} is molar flow rate into anode (mol/s) and V is a total anode sub-system volume (L).

7. The method according to claim 6 further comprising comparing the observed pressure to the desired pressure to determine whether the anode sub-system pressure is at the desired pressure.

8. The method according to claim 1 wherein providing hydrogen gas to the anode sub-system includes using at least one injector having a predetermined duty cycle and determining how many moles of the hydrogen gas have been provided to the anode sub-system during the pressurization stage includes using the duty cycle of the injector.

9. The method according to claim 1 further comprising entering an anode purge stage after the pressurization stage.

10. A method for pressurizing an anode sub-system of a fuel cell system to a desired pressure during a pressurization stage at system start-up, said method comprising:
providing hydrogen gas to the anode sub-system during the pressurization stage;
determining how many moles of the hydrogen gas have been provided to the anode sub-system;
using the pressure in the anode sub-system, a volume of the anode sub-system, a temperature of the hydrogen gas and the universal gas constant to determine the number of moles that are actually in the anode sub-system; and
comparing the number of moles of the hydrogen gas delivered to the anode sub-system with the number of moles in the anode sub-system to determine whether the pressure in the anode sub-system has reached the desired pressure.

11. The method according to claim 10 wherein determining how many moles of the hydrogen gas have been provided to the anode sub-system includes using a valve model.

12. The method according to claim 10 further comprising entering an anode purge stage after the pressurization stage.

13. The method according to claim 10 wherein providing hydrogen gas to the anode sub-system includes using at least one injector having a predetermined duty cycle and determining how many moles of the hydrogen gas have been provided to the anode sub-system during the pressurization stage includes using the duty cycle of the injector.

14. The method according to claim 10 wherein using the pressure in the anode sub-system, the volume of the anode sub-system, the temperature of the hydrogen gas and the universal gas constant to determine the number of moles that are actually in the anode sub-system includes using the equation:
$${\int }_{0}^{t} \dot{n} d t \leq \frac{( {P}_{final} - {P}_{int} ) \cdot V}{RT}$$
where P_{final} is the desired anode sub-system pressure at the end of the pressurization stage (kPa), Pᵢₙₜ is an anode sub-system pressure at the start of the pressurization stage (kPa), R is the universal gas constant (8.314 J/mol*K), T is the hydrogen gas temperature (K), \dot{n} is the molar flow rate into anode sub-system (mol/s) and V is the anode sub-system volume (L).

15. A method for pressurizing an anode sub-system of a fuel cell system to a desired pressure during a pressurization stage at system start-up, said method comprising:
providing hydrogen gas to the anode sub-system during the pressurization stage;
determining how many moles of the hydrogen gas have been provided to the anode sub-system during the pressurization stage;
using the number of moles provided, a volume of the anode sub-system, a pressure of the anode sub-system at the start of the pressurization stage, a temperature of the hydrogen gas and the universal gas constant to determine an observed pressure within the anode sub-system; and
comparing the observed pressure to the desired pressure to determine whether the anode sub-system pressure is at the desired pressure.

16. The method according to claim 15 wherein providing the hydrogen gas to the anode sub-system includes using at least one injector having a predetermined duty cycle and determining how many moles of the hydrogen gas have been provided to the anode sub-system during the pressurization stage includes using the duty cycle of the injector.

17. The method according to claim 15 wherein determining how many moles of the hydrogen gas have been provided to the anode sub-system includes using a valve model.

18. The method according to claim 15 further comprising entering an anode purge stage after the pressurization state.

19. The method according to claim 15 wherein using the number of moles of the hydrogen gas to determining the pressure within the anode sub-system includes using the equation:
$${P}_{obs} = \frac{[ {\int }_{o}^{t} \dot{n} d t ] \cdot RT}{V} + {P}_{int}$$
where P_{obs} is the observed anode sub-system pressure, (kPa), Pᵢₙₜ is an anode sub-system pressure at the start of the pressurizations stage (kPa), R is the universal gas constant (8.314 J/mol*K), T is the hydrogen gas temperature (K), \dot{n} is molar flow rate into anode (mol/s) and V is the total anode sub-system volume (L).
